(19) United States
(12) Patent Application Publication
(10) Pub. No.: US 2021/0007523 A1
(43) Pub. Date: Jan. 14, 2021

(54) Portable personal locker with rack

(71) Applicant: Jay Baek, San Diego, CA (US)

(72) Inventor: Jay Baek, San Diego, CA (US)

(21) Appl. No.: 16/509,379

(22) Filed: Jul. 11, 2019

(51) Int. Cl. A47G 29/14; B25J 5/00

(52) U.S. Cl. CPC A47G 29/141; G07F 17/12; B25J 5/007

(57) ABSTRACT

Disclosed is a command sensitive personal locker device designed to assist with household chores, in an effort to modernize home economics. The locker serves as a courier and handler primarily for laundry and dry cleaning services however, such a device may also facilitate secure delivery and pickup of any type of good. Inside the locker there is a storage area outfitted with a clothing rack. The storage area has two points of access, one facing horizontally and one facing vertically. The locker is outfitted with motorized wheels, GPS, a security system, a CPU and a microphone. The locker is capable of responding to stimuli as well as digital and verbal commands via a network connection. Such a locker is hailed by an individual or triggered by stimuli to receive, store, move or deposit goods.

### CROSS-REFERENCE TO RELATED APPLICATIONS

Not applicable.

### STATEMENT REGARDING FEDERALLY SPONSORED RESEARCH OR DEVELOPMENT

Not applicable

### BACKGROUND OF THE INVENTION

### Field of Invention

The present invention relates to the field of portable storage lockers or laundry boxes.

### Background of the Invention

As the hustle and bustle of daily life for most people tends to compound over time, many find it increasingly difficult to fit room for daily chores into their schedules. As such, courier services have recently mitigated the difficulty experienced by most in the working world in fields from grocery shopping to retail goods. With the click of a button, one can order food for the week, parts to repair their automobile, and they can even schedule someone to care for their pet.

This time-saving technique has yet to be applied to most other areas of home life. For example, a working individual having to come home only to find that their laundry has yet to be completed may find that exceedingly bothersome. Further, even a trip to the post office to pick up or drop off a package may inconvenience the average person to an unsuitable level.

Thus, there exists a need to introduce a device to further streamline and modernize home economics as well as other areas. Such a device and method is not to be limited to the home life, however, as the same principles can be applied in the workplace or elsewhere where attention to work-life is displaced or limited by the need to attend to other errands or the like.

### SUMMARY OF THE INVENTION

Accordingly, it is an object of the present invention to ease the burden experienced by working individuals in their daily lives as they attend to both work and non-work-related matters by disclosing a personal locker device. The device taught here serves mainly as a laundry basket. While its main daily use is collecting and storing laundry and dry cleaning, one of skill in the art will readily recognize other useful applications of such a device.

Because the device taught here applies to courier services, another object of the present application is to facilitate secure delivery and pickup of goods.

The device taught is a locker device suited for indoor and outdoor use. The locker device is protected by a security system, employing a wide range of defense measures. Among other things, the security system will have a camera, some embodiments having both a camera and a microphone while others may have either or both.

The device in its entirety may be controlled by the user remotely via a network connection or else by artificial intelligence. The network connection may feed and source the required data to and from the locker's control system. The control system is also partially responsible for supporting communications between the user and the courier.

The locker is contemplated to have motorized wheels, connected digitally to the control system to allow the locker to be autonomously mobile given a set of commands stored in computer readable memory via a central processing unit (CPU). The user may name the device, which will use the control system and the motorized wheels to respond to the user's verbal or digital request. Further, the user may engage the locker's lock via the same control system.

Naturally, a benefit lending to the presence of motorized wheels, a CPU, and a microphone and other integrated features described is that the locker may respond autonomously to various stimuli. A user, wanting to put their clothes or other items in the locker, could hail the locker from inside or across the home by simply calling it. The locker would then approach the user and, based on the user's settings, open the top or main door. This feature would be especially useful in larger homes with multiple inhabitants by centralizing the chores to be done, such as laundry.

The device taught likewise employs a cooling system, passive or active depending on the embodiment, to cool the control system and the contents of the locker.

Because the locker is suited to carry all type of valuable cargo, the locker is to be fitted with a GPS unit or other means of tracking. The GPS unit can also be used in connection with autonomous control of the locker. It is contemplated that the GPS unit may also be integrated more seamlessly into the security system by allowing the user to create a geofence, or virtual boundary. Should the locker be taken past this boundary set by the user, the locker may automatically lock and send the user a distress signal.

### BRIEF DESCRIPTION OF THE FIGURES

Other objectives of the invention will become apparent to those skilled in the art once the invention has been shown and described. The manner in which these objectives and other desirable characteristics can be obtained is explained in the following description and attached figures in which:

FIG. 1 is a perspective view of the locker in one embodiment.

FIG. 2 is a frontal view of another embodiment of the locker.

FIG. 3 is a perspective view of one embodiment of the locker in which the top opens.

FIG. 4 illustrates the connected network of the locker, including some of the integrated security measures and how they are connected.

FIG. 5 illustrates the aerial pick-up and delivery system, in this case employing drones, picking up and dropping off the locker.

FIG. 6 illustrates a particular embodiment in which the locker has a voice-control functionality.

FIG. 7 shows the locker being hailed by voice from inside a home.

In the figures, the following reference numbers represent the associated components of the disclosed device:
Locker device—100;
Main door—110;
Top door—120;
Wheels—130;
Vents—140;
Handle—150;
Rack apparatus—200;
Attachment device—210;
Security System—300;
Alarm system—310;
Lock—320;
Control apparatus—330;
Camera—340;
Home security system;
GPS tracking unit—360; and
Delivery device—400.

It is to be noted, however, that the appended figures illustrate only typical embodiments of this invention and are therefore not to be considered limiting of its scope, for the invention may admit to other equally effective embodiments that will be appreciated by those reasonably skilled in the relevant arts. Also, figures are not necessarily made to scale but are representative.

### DETAILED DESCRIPTION OF PREFERRED EMBODIMENTS

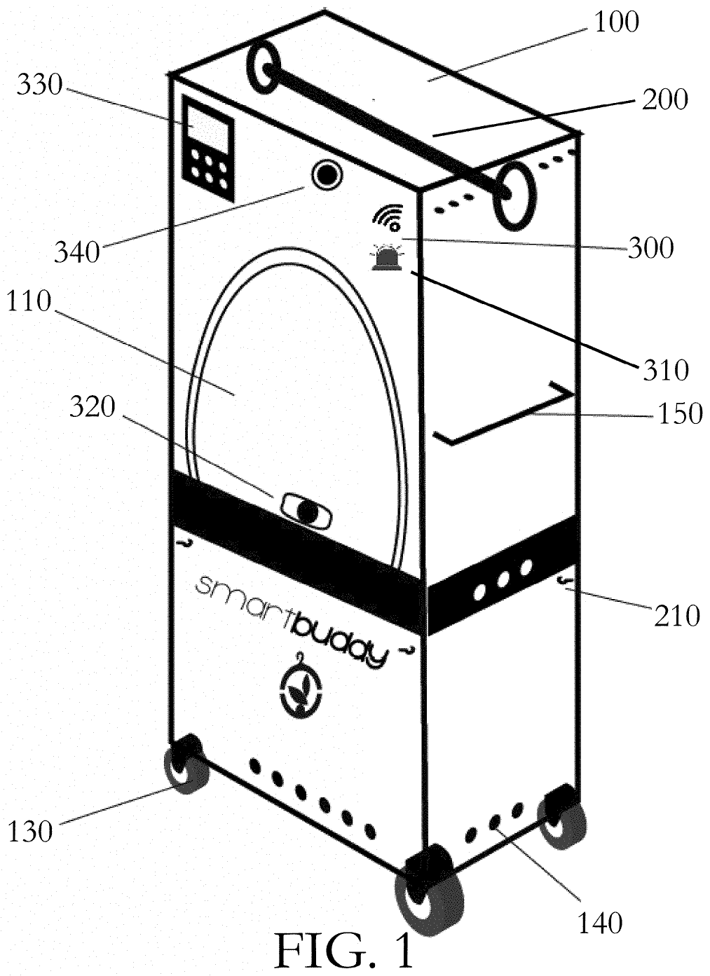

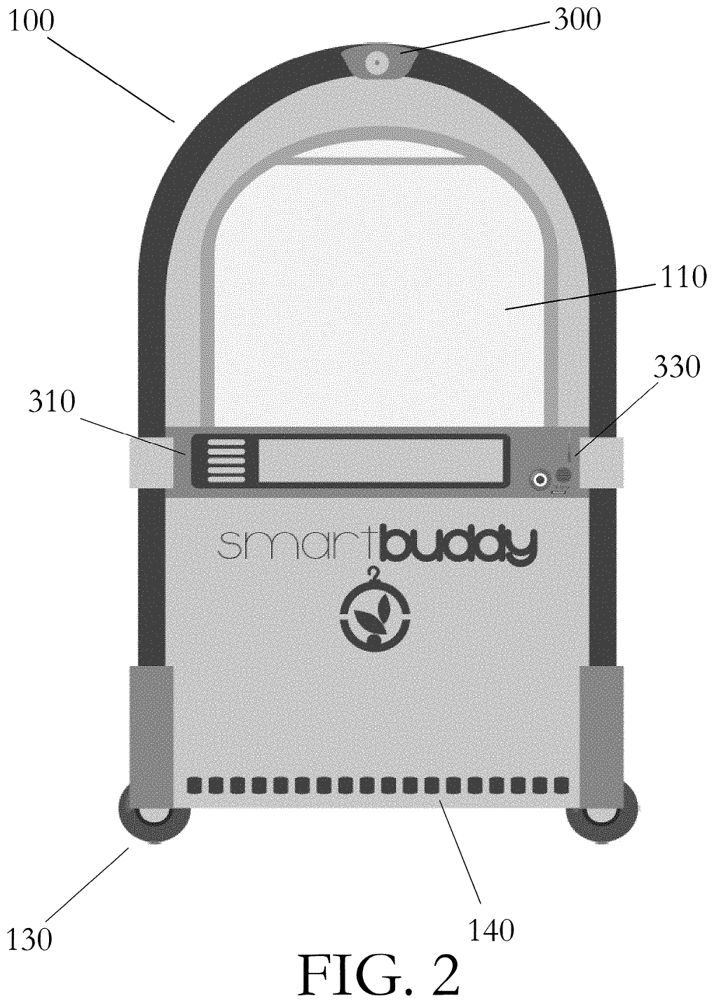

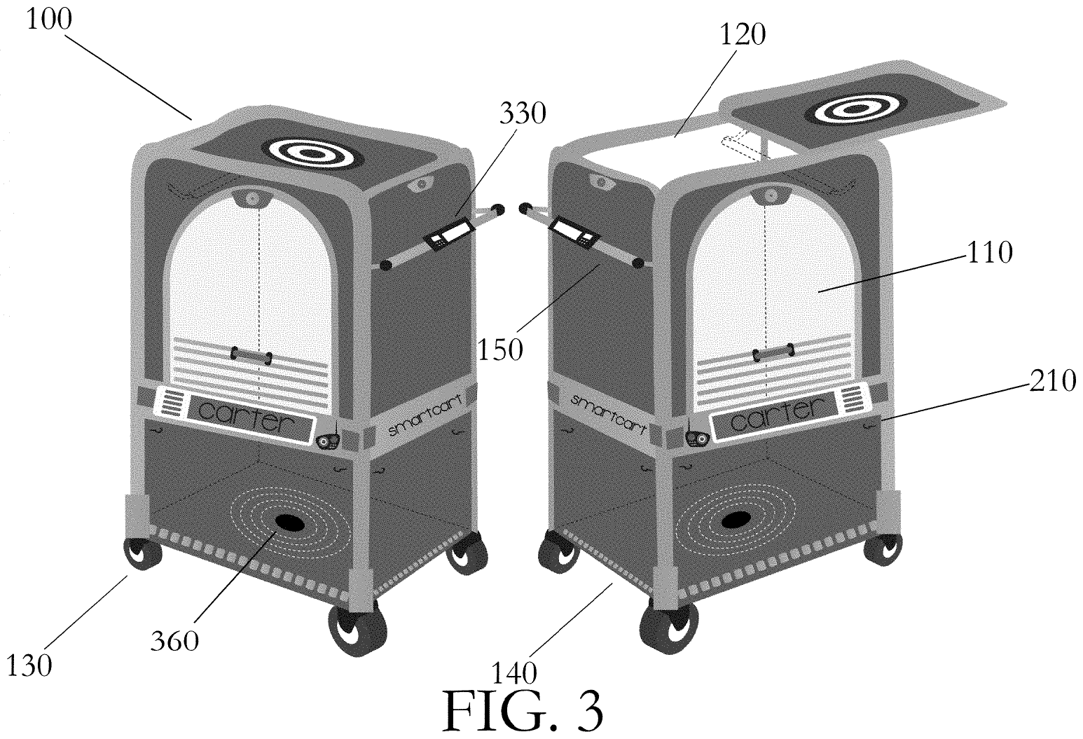

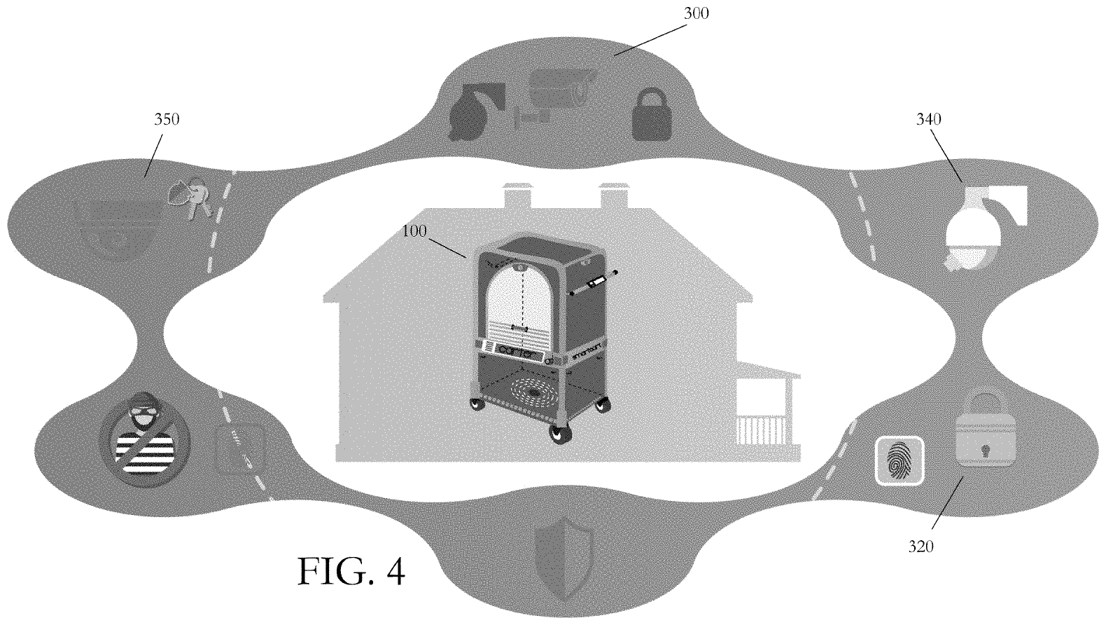

Disclosed is a personal, portable security locker. The device disclosed may be used to safeguard items as they await pickup or drop off by a courier service or the like. FIG. 1 is a perspective view of the locker 100. FIG. 2 is a frontal view of another embodiment of the locker 100. FIG. 3 is a perspective view of one embodiment of the locker 100 in which the top door 120 is shown both opened and closed. FIGS. 4 through 7 illustrate various functional aspects of the locker.

FIG. 1 shows the preferred embodiment of the locker 100 in which it is fitted, among other things, with a rack apparatus 200 for hanging clothes and a camera 340. The clothes, or whatever other contents, may be ventilated via the vents 140 so as to not entrap unpleasant odors. The user may open the main door 110 to insert the intended item or items into the locker 100 and then lock the main door lock 320. The main door 110 may be attached at a hinge point, or may be rolled up or down (manually or electronically) in the same fashion as modern automobile windows. The user may then use a smart phone or other network-connected device to engage the locker security system 300 via use of the control apparatus 330. The control apparatus 330 controls all operating functions of the locker 100.

Should anyone break the locker, the alarm system 310 will sound. The alarm system 310 monitors the status of the locker 100 via WiFi network connectivity—some embodiments contemplate using wired or Bluetooth connections. Further, the user may manually engage the alarm system 310 via a mobile device and may view the feed of the camera 340. The security system 300 may comprise various elements such as audio recorders and speakers, and may or may not be centrally located on the locker. FIG. 1 shows an embodiment in which the control apparatus 330 is external to the locker 100, but some embodiments may teach a locker where the control apparatus is housed completely separate of the device, such as an application on a mobile device.

It is contemplated that the locker 100 may also serve as a laundry basket where it may also be introduced into or removed from the home to serve doubly as a personal safety locker. The main use of the locker 100 is that of a laundry basket or hamper and as a personal safety locker when exchanging goods.

When not in use or upon waiting for completion of a scheduled delivery or pick-up, the locker may be secured via the lock 320 and left outside the home. The user, after requesting a pick-up or awaiting a drop-off, need only wait as all commands are communicated via a network connection.

Within the locker, there is a rack apparatus 200 capable of being fitted with various attachment devices 210 as to allow the user to fix or remove with ease a rack or other fittings suitable to hold a hamper. The attachment devices 210 attach via internal ports. After the courier has returned the clean clothes or delivered the items, and re-locked the lock 320, the items may sit securely within the device, sheltered from various weather conditions and theft until the user decides to retrieve them.

FIGS. 1 through 3 depict embodiments comprising wheels 130 purposed to make the locker 100 more portable. The wheels 130 are connected to an electric motor and remotely controlled steering system (not shown) as will be appreciates by one of skill in the art. Remote control of the steering system may be accomplished by the user or via an artificial intelligence or machine learning system. One embodiment of the locker 100 purposed to facilitate delivery of dry cleaning is shown in FIG. 3 in which there is also a top door 120 in addition to the main door 110. This type of embodiment may or may not employ the use of a rack apparatus 200. FIGS. 1 and 3 illustrate an embodiment in which there are attachment devices 210 located near the base of the locker 100. These attachment devices 210 may be used to hold hampers for laundry or a variety of other things requiring secure, fixed storage.

FIG. 2 shows a different embodiment of the locker 100 with a varying shell shape. Various embodiments of the locker encompassing differences such as in the general shape may be produced to fit the practical and aesthetic demands of the consumer. As illustrated in FIG. 2, some items such as the control apparatus 330, alarm system 310, lock 320, vents 140, and other items may occupy different positions on the locker or may be omitted from the produced embodiment upon customer request. Another example in FIG. 3 shows the control apparatus 330 mounted on the handle 150.

FIG. 3 shows a GPS tracking unit 360 placed on the bottom of the locker. The GPS tracking unit 360 is an integrated part of the whole security system 300, allowing the user to, via the use of a mobile or other electronic device, check the location of the locker 100 at all times. The user may use the data from the GPS unit 360 to remotely lock the locker's lock 320 by accessing a control apparatus 330 on the locker or as an application on the user's device. A GPS device 360 may be used to facilitate autonomous control of the locker 100.

FIG. 4 shows the connected network of the locker, including some of the integrated security measures and how they are connected. The locker 100 has a camera 340 integrated as part of its security system 300. The camera 340 may be accessed by the user via the control apparatus 330 or via a mobile device. Additionally depicted is the lock 320. In this particular embodiment, the lock 320 is engaged via the user producing a correct fingerprint. The camera 340 communicates with the security system 300 which in turn can feed data to the user's compatible home security system 350. It should be noted that the type of camera 340 incorporated should not be limited to a ball-style camera as depicted. Other embodiments of the locker may have the camera discreetly housed as FIG. 1 does. As one skilled in the art will appreciate, the integrated camera system 340 may be used to assist in remotely controlling the locker 100.

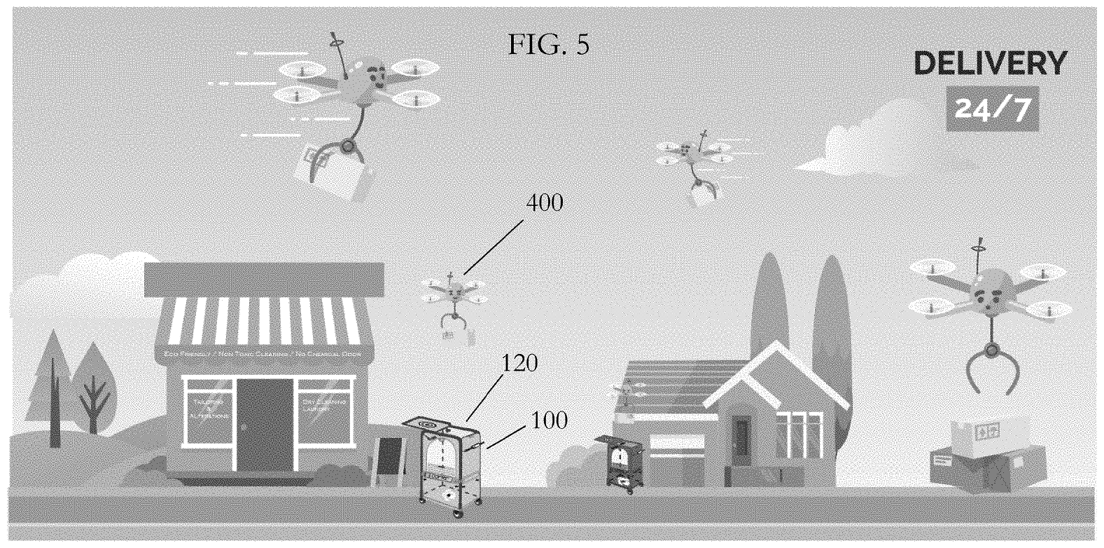

FIG. 5 shows a configuration of the locker 100 in which the top door 120 is in the open position to receive or provide a package from or to a delivery device 400. In this case, the delivery device 400 is embodied by a drone aerial craft. FIG. 5 also shows the locker 100 being exposed to the elements, a nonissue due to the weatherproofing. The top door 120 suitably features a target for the drone or other delivery device 400 to interact with. The drone or other delivery device 400 may communicate with the locker 100 via the control apparatus 330 to open the top door 120 or main door 110.

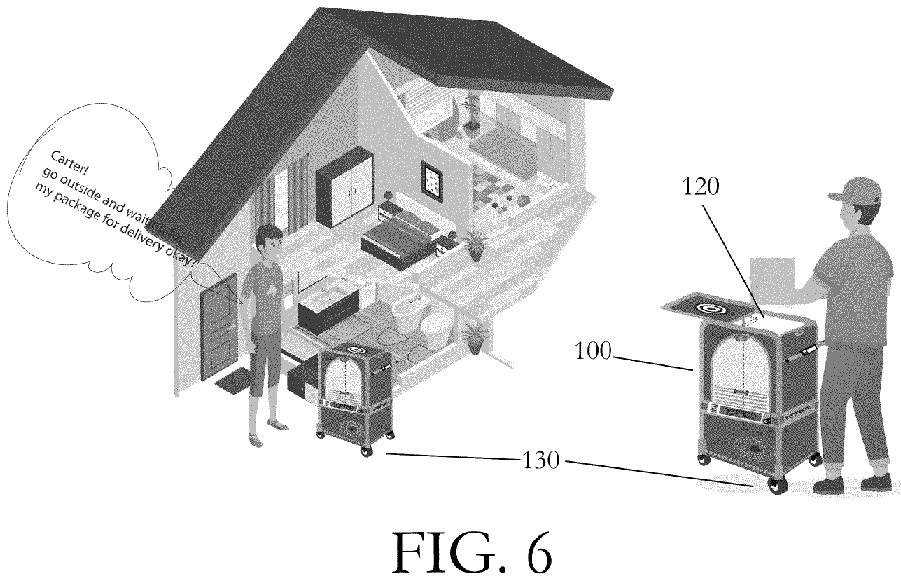

FIG. 6 gives an example of how the voice activation system or response function might work. A user may give the locker a “name,” which the user may use in the future to engage the device. FIG. 6 also illustrates a courier inserting a package into the locker 100 via the top door 120. The locker 100 is suited for both indoor and outdoor use, being fitted in some embodiments with a set of wheels 130 suited for both indoor and outdoor use. FIG. 6 likewise illustrates how a user or delivery device 400 may command the top door 120 to open.

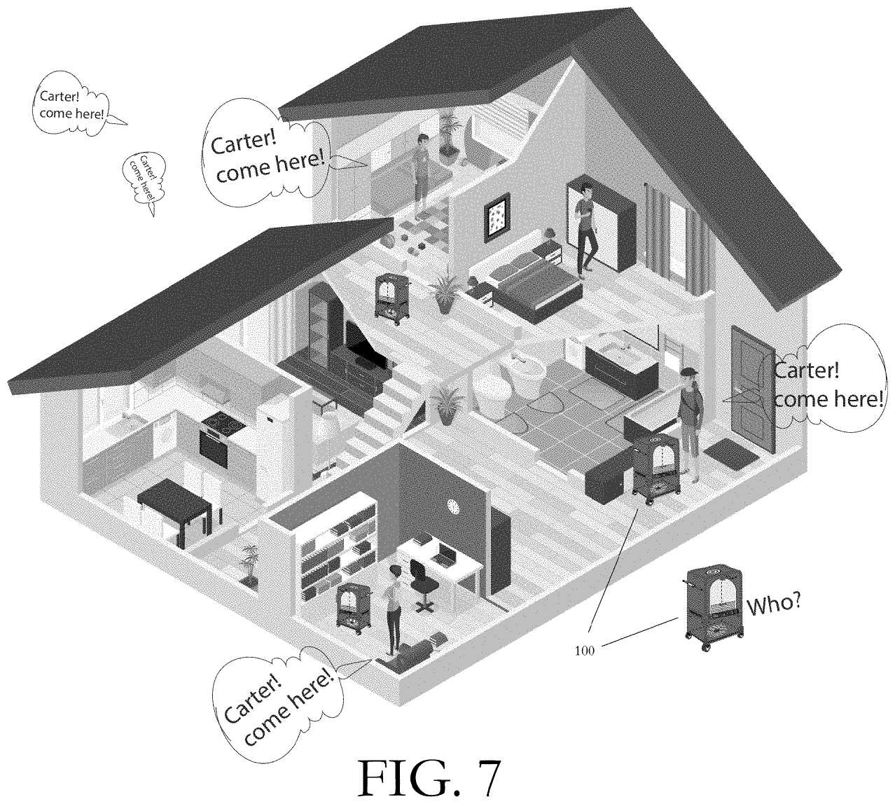

FIG. 7 shows how the locker 100 may function within the home. A user may call the locker 100 by name, causing the locker to move towards the user. The locker 100 may use the integrated camera 340 and other aspects of the device's control apparatus 330 to navigate autonomously. One of skill in the art will appreciate how to incorporate the features of this device to home use.

Other possible embodiments not shown here are also possible. The purpose of the locker is not to be limited to activities related to laundry and dry cleaning. Additionally, the pick-up and drop off methods may differ depending on user and courier preferences. In some embodiments, the locker may be fitted with fittings, internal or external, which allow for placement of various accessories. Such fittings include but are not limited to internal components purposed to hold open laundry or other hampers such as the attachment devices 210 shown in FIG. 1, and external fittings to allow for couriers to easily open or move the locker.

Other assembly methods may be practiced depending on the use of alternative embodiments described herein, and will be readily apparent to those skilled in the art.

Although the device is described above in terms of various exemplary embodiments and implementations, it should be understood that the various features, aspects, and functionality described in one or more of the individual embodiments are not limited in their applicability to the particular embodiment with which they are described, but instead might be applied, alone or in various combinations, to one or more of the other embodiments of the disclosed device, whether or not such embodiments are described and whether or not such features are presented as being a part of a described embodiment. Thus, the breadth and scope of the claimed invention should not be limited by any of the above-described embodiments.

Terms and phrases used in this document, and variations thereof, unless otherwise expressly stated, should be construed as open-ended as opposed to limiting. As examples of the foregoing: the term “including” should be read as meaning “including, without limitation” or the like, the term “example” is used to provide exemplary instances of the item in discussion, not an exhaustive or limiting list thereof, the terms “a” or “an” should be read as meaning “at least one,” “one or more,” or the like, and adjectives such as “conventional,” “traditional,” “normal,” “standard,” “known,” and terms of similar meaning should not be construed as limiting the item described to a given time period or to an item available as of a given time, but instead should be read to encompass conventional, traditional, normal, or standard technologies that might be available or known now or at any time in the future. Likewise, where this document refers to technologies that would be apparent or known to one of ordinary skill in the art, such technologies encompass those apparent or known to the skilled artisan now or at any time in the future.

The presence of broadening words and phrases such as “one or more,” “at least,” “but not limited to,” or other like phrases in some instances shall not be read to mean that the narrower case if intended or required in instances where such broadening phrases might be absent. The use of the term “assembly” does not imply that the components or functionality described or claimed as part of the module are configured in a common package. Indeed, any or all of the various components of a module, whether control logic or other components, might be combined in a single package or separately maintained and might further be distributed across multiple locations.

Additionally, the various embodiments set forth herein are described in terms of exemplary block diagrams, flow charts, and other illustrations. As will become apparent to one of ordinary skill in the art after reading this document, the illustrated embodiments and their various alternatives might be implemented without confinement to the illustrated examples. For example, block diagrams and their accompanying descriptions should not be construed as mandating a particular architecture or configuration.

All original claims submitted with this specification are incorporated by reference in their entirety as if fully set forth herein.

I claim:

1. A personal locker device comprising:
an electronic control system accessible by the user;
wherein the control system comprises a security system.
a courier communication system;
a plurality of internal and external connection ports capable of receiving and holding attached accessories;
a cooling system;
wheels; and
at least one door or hatch to allow for access to the contents inside.

2. The locker of claim 1, wherein the control system has an access point on the outside of the locker and is also accessible remotely by a user via a mobile device.

3. The locker of claim 1, wherein the courier communication system allows the user and courier to communicate, among other things, delivery and pick-up statuses.

4. The system of claim 3, wherein the communication system permits the user to monitor the delivery or pick up status of the contents within the locker via a smart phone application.

5. The locker of claim 1, wherein the cooling system may be either active or passive.

6. The locker of claim 1, wherein the electronic control system, being set to lock by the user, notifies the user upon any successful or attempted unauthorized entry into the locker.

7. The electronic control system of claim 6, wherein the system further comprises a security system equipped with a plurality of cameras to monitor the locker.

8. The security system of claim 7, further comprising a GPS unit mounted on or in the locker where the user may retrieve the geographical location of the locker at all times via a mobile application.

9. The locker of claim 1, wherein the electronic control system is capable of receiving audio input via a microphone system.

10. The wheels of claim 1, wherein they are motorized and digitally connected to the electronic control system.

11. The locker of claim 1, wherein the external ports are capable of bearing the full downward load of the locker and contents.

12. The locker of claim 1, wherein the internal ports allow for fitting hamper hangers as well as a clothes rack.

13. The internal ports of claim 12, wherein the hanger rack may be removed or swiveled to make room for the top door of the locker to open, allowing the locker to receive cargo.
